(19) United States
(12) Patent Application Publication
(10) Pub. No.: US 2002/0172414 A1
(43) Pub. Date: Nov. 21, 2002

(54) Method and apparatus for locating elements of interest in a member

(76) Inventors: Serge Muller, Guyancourt (FR); Andreas Rick, Schwerte (DE)

Correspondence Address: General Electric Company, 3135 Easton Turnpike - W3C, Fairfield, CT, 06431, US

(21) Appl. No.: 10/116,637

(22) Filed: Apr. 4, 2002

(30) Foreign Application Priority Data
Apr. 30, 2001 (FR) 01 05818

(51) Int. Cl. G06K 9/36; G06K 9/00; G06T 7/60

(52) U.S. Cl. 382/154; 382/291; 382/132

(57) ABSTRACT

A method and apparatus for locating elements of a member from digital images taken at different angulations, in which elements present in a first digital image taken at a first angulation are determined. A deformation model of the member between the first angulation and another angulation is determined in order to deduce there from a search region in another digital image taken at the other angulation. Elements present are determined, in a search region of an element marked on the first image which has a high probability of being found. The image of the element is analyzed in order to assess their similarity.

### CROSS-REFERENCE TO RELATED APPLICATIONS

This application claims the benefit of a priority under 35 USC 119 to French Patent Application No. 0105818 filed Apr. 30, 2001, the entire contents of which are hereby incorporated.

### BACKGROUND OF THE INVENTION

The invention relates to three-dimensional location of elements of interest in a member from a set of images of the member.

Although the invention is applicable to any set of images of any member, it is particularly useful in the medical field and especially in mammography during a cytological analysis or a histological analysis in which it is desired to sample part of the breast.

Following a screening examination, when radiological signs which could be associated with a cancer, microcalcification in particular, are discovered in a patient, an additional diagnostic examination is carried out, which may itself be complemented by an interventional radiology examination. During the latter examination, the physician may wish to take a sample, using a needle, from a region of the breast whose cells are suspect for the purpose of a cytological analysis. This is then referred to as cytopuncture. The physician may also wish to take a sample, using a needle, from a suspect region of the breast, of organic tissue for the purpose of a histological analysis.

The puncture operation, that is to say the taking of cells or of a sample of organic tissue containing elements of interest, requires the accurate knowledge of the location in three dimensions of these elements. In the rest of the description, the term “element of interest” denotes a microcalcification or any other internal element of a member which may be of interest to an operator.

FR-A-2 751 109 discloses a method for locating an element of interest contained in a three-dimensional object from the positions of homologous regions of interest corresponding to the element of interest and appearing in a set of stereotaxic images of the object. Firstly, a first region of interest called “target” is selected in a first stereotaxic image. Then the first region is matched with a second region of interest homologous to the first and appearing in a second stereotaxic image. As the stereotaxic images are digitized, a target pixel is selected in the target region of interest. In the matching step, a target window of selected dimensions and containing the target region of interest is generated around the selected target pixel. In the second image, a set of pixels is then determined according to a predetermined selection criterion and a second window of the same dimensions as the target window is generated about each selected pixel. Correlation processing between the grey levels of the pixels of each second window and the grey levels of the pixels of each second window and the grey levels of the pixels of the target window is carried out, so as to obtain a correlation value for each second window. Then the region of interest is identified from analysis of the set of correlation values thus obtained, so as to minimize the risks of matching error between the homologous regions of interest.

However, this procedure means the selection of the region of interest takes place on the two-dimensional images. If this selection is carried out manually, the operator chooses an element of the image which, according to the operator, represents a microcalcification. This is because a stereotaxic image comprises several elements of the image from which some represent microcalcifications and others are due to noise. It is often difficult to distinguish the microcalcifications from the noise since the stereotaxic images still do not have a good enough quality to be able to distinguish elements of interest. Even an automatic selection procedure on stereotaxic images still does not make it possible to correctly select a region of interest, above all when several elements form a cluster.

By selecting a target point from these two projections in two images, the physician does not know which position this target point occupies in the volume to be sampled, relative to other elements of interest. It would be beneficial, in particular, to puncture an element of interest which is found at the periphery or at the center of a group or cluster of elements of interest such as microcalcifications for example.

During a stereotaxic examination, the breast is compressed, and at least two pictures are acquired for different positions of the X-ray tube, but with the same breast compression geometry (breast not decompressed between the different pictures, just one tube angulation).

This method is well suited to receiving apparatus and breast-support and compression plates which remain fixed while the X-ray emitting tube takes different angular positions and therefore moves away from the normal to the receiving plane.

### BRIEF DESCRIPTION OF THE INVENTION

An embodiment of the invention is directed to a method and apparatus for locating elements of interest matched to images taken at different angulations of a means for emitting radiation, such as an X-ray emitter and means for receiving the emitted radiation.

An embodiment of the invention is directed to a method for locating elements of interest of a member from a plurality of images, preferably digital images, taken at different angulations and with different compressions by preferably by a means for receiving an image connected in rotation to a means for emitting radiation, such as a photon emitter, comprising:

determining elements of interest present in a first image taken at a first angulation;

determining a deformation model of the member between the first angulation and another angulation different from the first in order to deduce there from a search region in another image taken at the other angulation, in which search region an element of interest marked on the first image has a high probability of being found;

determining elements of interest present in the other digital image; and

analyzing the image of the elements of interest in order to assess their similarity.

An embodiment of the invention is directed to an imaging system comprising means for emitting radiation, such as a photon emitter; means for receiving the emitted radiation connected in rotation to the means for emitting radiation and a means for processing images acquired by the means for receiving. The means for processing comprises means for locating elements of interest of a member from a plurality of preferably digital images taken at different angulations by the means for receiving. The means for locating comprises means for determining elements of interest present in a first image taken at a first angulation, means for determining a deformation model of the member between the first angulation and another angulation different from the first in order to deduce there from a search region in another image taken at the other angulation, in which search region an element of interest marked on the first image has a high probability of being found, means for determining elements of interest present in the search region, and means to analyze the image of the elements of interest in order to assess their similarity.

An embodiment of the invention is directed to a computer program comprising means for providing program code for implementing the steps of the method, when the program runs on a computer.

An embodiment of the invention is directed to a storage medium that can be read by a device for reading program code means which are stored therein and which are capable of implementing the steps of the method when the program runs on a computer.

### BRIEF DESCRIPTION OF THE DRAWING

An embodiment for implementing the method and apparatus is illustrated in the accompanying figure, in which:

FIG. 1 is a schematic front view in elevation of a radiology apparatus;

FIG. 2 is a flow chart of steps of a method of one embodiment of the invention;

FIG. 3 is a representation of an image of a member taken along a first angulation;

FIG. 4 is a representation of the image of FIG. 3;

FIG. 5 is a representation of an image of the member of FIG. 3 taken along a second angulation different from the first angulation;

FIG. 6 is a representation of the image of FIG. 5 at the later step;

FIG. 7 is a flow chart of steps according to another embodiment of the invention; and

FIG. 8 is a flow chart of steps according to another embodiment of the invention.

### DETAILED DESCRIPTION OF THE INVENTION

The invention is directed to substantially reducing the risk of error in selecting the region to be punctured by obtaining an accurate location of the elements of interest in at least two views taken along different angulations.

In one embodiment, a user determines a region of interest and the image is analyzed in order to determine at least one element of interest present in the region of interest. The elements of interest are characterized from a list of parameters. The search region is also deduced from an a priori knowledge of the acquisition geometry. The similarity of the elements of interest is assessed over all the elements of interest of a search region corresponding to one element of interest of the first image. An element of interest is selected in the search region, the selected element of interest having the highest similarity with the element of interest having the highest similarity with the element of interest of the first image for which the search region was determined. The image analysis of the elements of interest to assess their similarity is carried out on the element of interest marked on the first image and on the elements of interest present in the corresponding search region.

In one embodiment, the image analysis of the elements of interest provides a list of parameters which can be compared.

The element of interest marked on the first image and the element of interest of the corresponding search region on the other image estimated as having the greatest similarity with the said element of interest marked on the first image, are displayed in a particular manner.

An examination requires firstly to take at least two images of the object at different angles, secondly to know completely the acquisition geometry of the system or to be able to reconstruct it from markers placed in the field of view and visible on the projective images, and thirdly, to be able to locate the location of the projection of the selected element of interest on the various images obtained.

In mammography, the examination is carried out using a mammograph equipped with a device for taking stereotaxic views. The mammograph comprises an X-ray tube, located at the end of an arm which can be moved about an axis and emitting X-ray radiation towards a receiver located at the other end of the arm. Between the tube and the receiver are placed, on the one hand, a breast-support plate or patient support, and on the other hand, a compression plate keeping the breast in place during mammography. The two plates are supported by the arm.

The means for receiving may be a digital receiver, such as a CCD camera combined with a scintillator or a solid-state detector for example delivering digitized images. Taking images requires rotating the arm about at least two successive orientations, for example, opposite either side of its initial position perpendicular to the plane of the means for receiving.

An embodiment of the present invention considers images of the organ acquired at various angles of incidence standard for mammography (CC, MLO, etc.). The breast is then compressed differently for each of these angles of incidence (hence a different deformation of the breast for each image in question). In order to make the connection between the structures of a breast projected onto an image according to a first angle of incidence (and therefore with a first deformation of the breast) and the structures of the breast projected onto another image according to a different angle of incidence (and therefore with a different deformation of the breast), a deformation model of the breast is formulated. The objective of locating an element of interest in an image along a certain projection, knowing the position of this element of interest in another image along another projection (and breast compression) is to be able to apply the same local image processing on the two images from a single operator action on just one of the images (e.g. zoom or filtering of the element of interest applied to the image A following operator action and applied automatically to all the other images B, C, D, etc., after locating the same element of interest in each of these images acquired along different angles of incidence and for different compressions of the member).

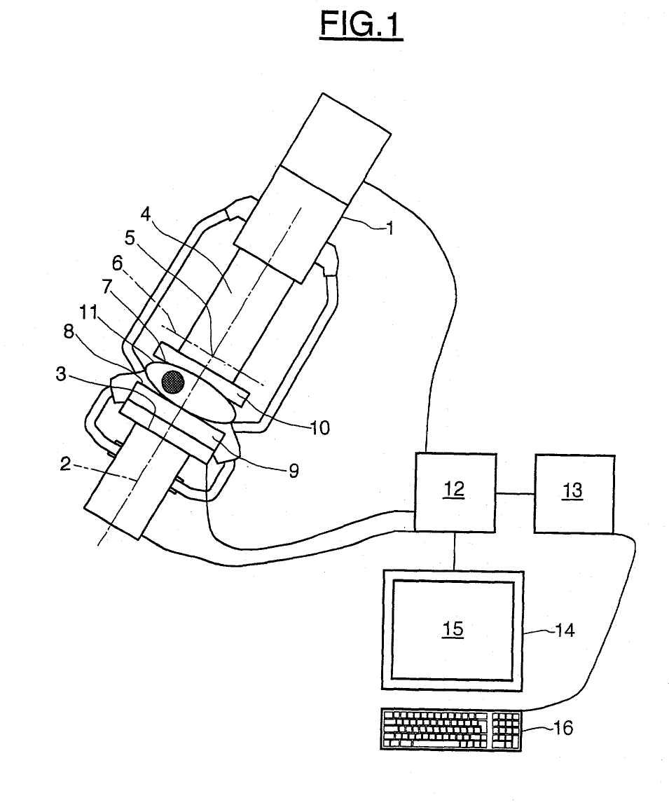

In FIG. 1, a radiology apparatus comprises an X-ray tube 1 capable of emitting an X-ray beam centered on an axis 2. A receiver 3 capable of transforming the incident X-rays into an electronic signal is placed in the path along which the X-rays centered on the axis 2, propagate. The receiver 3 may be provided with an X-ray detector of the solid-state type. The tube 1 and the receiver 3 are each supported at an opposite end by an arm 4 supported by a structure, not shown, and mounted so as to rotate with respect to the structure about an axis 5 perpendicular to the plane of the figure and which passes through the intersection of the axis 2 and the axis referenced 6, these three axes being mutually perpendicular. The arm 4, the tube 1 and the receiver 3 may be rotated through a complete turn with respect to the structure.

In FIG. 1, radiology apparatus with one axis has been shown. Of course, the present invention is also applicable to multi-axis radiology apparatus, for example, with a C-shape arm with three axes or with four axes.

The X-ray detector of the receiver 3 is provided with a scanning system for reading the matrix of elementary detection cells constituting the detector.

An examination, in particular in mammography, comprises a series of two exposures of a three-dimensional object 7, for example a breast, resting on an upper surface 8 of a support plate 9 and compressed by a compression plate 10. A filter (not shown) may be placed at the output of the tube so as to select a range of X-rays. An element of interest 11 forming part of the object 7 has been shown. It may be for example, a microcalcification in a breast.

The next step is an exposure at an angle of 0° in order to center the region of interest, and after, decompression of the breast and recompression for two exposures at two angles which are generally equal and of opposite signs, with typical values of ±15°. However, a number of images greater than 3 may also be provided.

A detector of the receiver 3 makes it possible to pick up the X-rays emitted by the tube 1 and which have passed through the compression plate 10, the three-dimensional object 7 and the support plate 9 and to convert them into visible photons. In this way, digitized stereotaxic images are obtained. These images comprise light spots which could be microcalcifications or which could be spurious, that is to say, noise arising from the acquisition.

At least one of the images thus obtained may undergo automatic detection of microcalcifications. Several methods for detecting microcalcification on a noisy image exist and are known to the person skilled in the art.

The radiology apparatus also comprises a means for control 12 connected to the X-ray tube 1, to the receiver 3 and to the arm 4, which is generally equipped with a motor, not shown, capable of rotating it. The means for control 12 is capable of generating control commands for the X-ray tube 1 and for the arm 4 and of receiving an image signal coming from the receiver 3. The means for control 12 is also connected to a means for processing 16 capable of processing the image and provided with a human-machine interface, especially a monitor 14 provided with a screen 15 and a keyboard 16. Of course, other types of human-machine interface may be provided, for example, means for printing or projecting the image, a pointer control means of the mousetype, control-handle type, etc. The means for processing 13 comprises at least one microprocessor, at least one memory, at least one software program stored in memory and capable of being executed by the microprocessor and a communication bus.

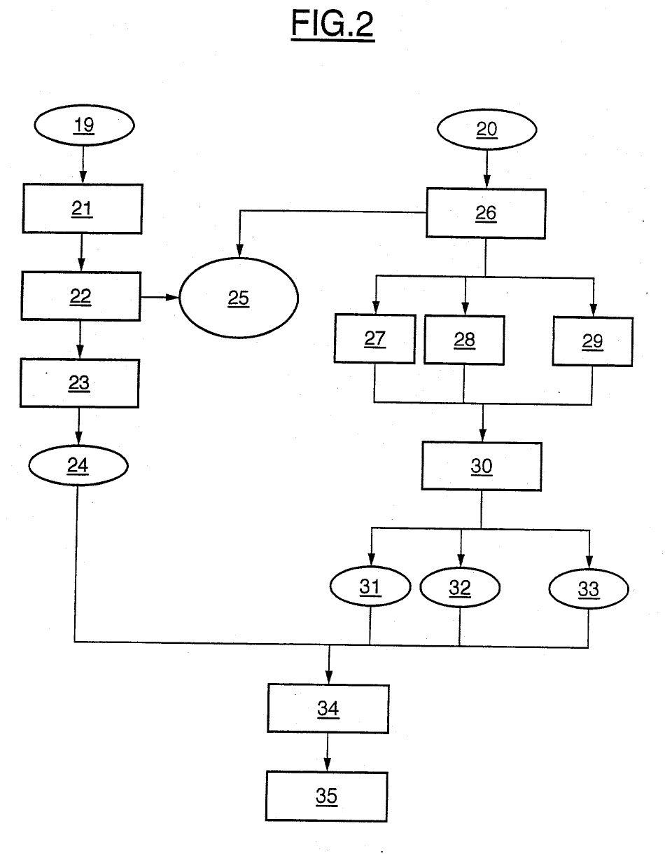

FIG. 2 illustrates the various steps of a location method according to one embodiment of the invention. Here, the case of locating an element of interest in two images is considered. The method may of course be applied to locating elements of interest in a number of images greater than two. An operator of an imaging system has available two images 19 and 20, for example mammograms, showing the same object taken at different viewing angles with rotation of the photon emitter and a receiver occurring simultaneously, the object being relatively soft and capable of undergoing elastic deformation between the position of taking the image 19 and that of taking an image 20 due to a compression geometry which is different between taking the two images (e.g. front and profile views). During a step 21, the operator determines a region of interest in the image 19. It is also possible to envisage that the region of interest is determined automatically by the image processing system.

Following step 21, a step 22 of determining an element of interest present in the region of interest determined in step 21, is implemented by the image processing system. The determination of an element of interest in a region of interest is known per se from, for example, FR-A-2 751 109 and FR-A-2 792 749.

The processing system then implements a step 23 for analyzing the image of the element of interest or for a particular window of the complete image containing the element of interest in order to deduce there from a list of parameters 24, capable of characterizing the element of interest. The parameters 24 may comprise dimensional criteria of the element of interest, and criteria relating to the grey level such as a minimum threshold, a maximum threshold, a variance, a gradient, etc.

Following step 22 of determining an element of interest, a deformation model of the object and of image acquisition geometry is implemented, to estimate the deformation of the object studied between the angulation at which the image 19 is taken and the angulation at which the image 20 is taken. In step 26, the processing system applies the model from step 25 to the image 20. The angulations at which images 19 and 20 were taken can be determined automatically or else manually, see for example, FR-A-2 786 387. Step 26 selects a search region smaller in size than the whole of the image 20 and/or smaller in size than that of the object studied in the image 20.

Next, steps for determining the elements of interest present in the search region are implemented. These steps are similar to step 22 described above and are referenced 27 to 29. For clarity of the drawing, only three elements of interest are to be determined, one by step 27, another by step 28 and the last by step 29. However, it is well understood that the number of elements of interest determined in a research region is widely variable from zero to a number which may be relatively high. These elements of interest are called “candidates”, in the sense that one of them may be considered as corresponding to that of image 19.

Following steps 27 to 29, the image processing system implements a step 30 of image analysis of the candidate elements of interest, similar to step 23 described above. Thus a list of parameters 31 characterizing the element of interest determined in step 27, a list of parameters 32 characterizing the element of interest determined in step 28 and a list of parameters 33 characterizing the element of interest determined in step 29, is obtained. In step 34, the similarity of the elements of interest is assessed on the basis of a comparison of the list of parameters 24 of the element of interest of image 19 and the list of parameters 31 to 33 of the candidate element of interest of the image 20. In step 35, the element of interest of the image 19 and the most similar element of interest of the image 20 are processed. The processing of step 35 may comprise a simultaneous display of the result of processing (zoom, filtering, etc.) applied to the element of interest of the image 20 and to the most similar element of interest of the image 20 on two screens or else on two windows of the screen 15.

The above has been explained with reference to a single element of interest of a single region of interest of the image 19. It will be understood that a region of interest may have several elements of interest for which the method will be implemented. Similarly, an object may contain a plurality of regions of interest.

The method is particularly beneficial in the field of mammography where a breast is deformed between a support plate and a compression plate in order to equalize its thickness and to be deformed elastically in a very important way. Its deformation is different between one image acquisition of the cranio-caudal type and one image acquisition of the medio-lateral oblique type, for example at 30°. The invention facilitates the identification of two elements of interest corresponding to the same structure in two images taken at different angulations, and this in a considerably more accurate manner than a simple estimation by an operator which generally refers to the distance of the identified element of interest with respect to the pectoral muscle.

An embodiment of the invention therefore allows the accurate identification and a reduction in time taken to identify the same structure on two images displayed at the same time. The definition of the region of interest of step 21 may be made by bringing the pointer controlled by a mouse to a point that the operator considers beneficial and of providing a region of interest in the form of a square of predefined dimension. Alternatively, the operator may also define the size of the region of interest.

Furthermore, the parameters characterizing an element of interest may comprise the texture, the variance in texture, the particle size distribution, the fractal dimension, and this before or after segmentation.

Step 34 for estimating similarity may be carried out as follows. Since each element of interest is characterized by n parameters P, the parameters of the element of interest of the image 19 are called P_{0,1,} to P_{0, n}. Since m elements of interest have been marked in the corresponding search region, their parameters are called P_{1,1} to P_{1,n} for the first and P_{m,1} to P_{m,n} for the last. These parameters form a vector space in which it is desired to find the vector closest to that defined by the parameters of the element of interest of the image 19. To this end, it is possible to use fuzzy logic to assess the similarity and the dissimilarity between the elements of interest. Of course, the parameters can be weighted according to their relative importance. Next, similarity rules and matrices are constructed by learning, depending on the usual technique with regard to fuzzy logic.

Steps 26 for determining the search region takes into account the deformation of the object. In the case of mammography, the extent of compression, that is to say the distance between the upper surface of the support plate and the lower surface of the compression plate, and the external surface area of the object are known by processing the image in order to determine the edge of the object, and the compressive force and possibly the mean density of the object are known by means of a prior setting-up stage. It is then possible to implement a mechanical model of the object based on the finite element theory.

The output information that might be given to the operator could be an estimate of the probability of correspondence between two elements of interest from images 19 and 20 displayed in the form of a positive expression, a negative expression or an interrogative expression where there is doubt on the correspondence, or even in the form of a percentage conveying the confidence level of the correspondence.

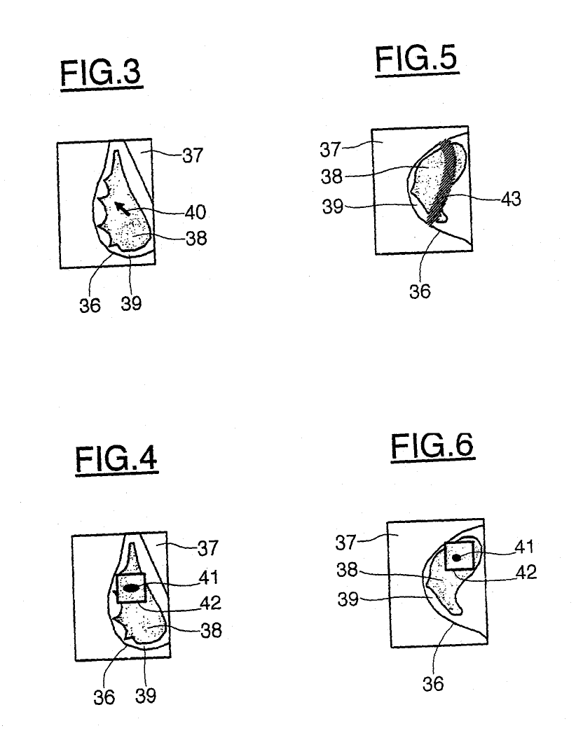

FIG. 3 shows the image 19, taken for example on the medio-lateral oblique angulation. The external outline of the breast 36, the pectoral muscle 37 and the glandular region 38, which has a slightly higher absorption of X-rays than the peripheral region 39, also called the adipose region, can be distinguished therein. The operator can move the pointer 40 to select a region of interest, see step 21.

FIG. 4 shows the same view in which an element of interest 41 appearing in the middle of a window 42 can be seen, see steps 21 and 22.

FIG. 5 illustrates an image taken at another angulation, here an angulation of the cranio-caudal type of the same breast as that shown in FIGS. 3 and 4. The pectoral muscle is no longer visible. The shape of the external outline 36, of the glandular region 38 and of the adipose region 39 has changed considerably. A search region 43 has been determined, in which it is estimated that the structure of the element of the interest 31 must be found, see step 26.

FIG. 6 shows the element of interest 41 marked in the search region 43 of FIG. 5 and to which the window 42 is applied with a view, for example to increasing the magnification for a better display of the element of interest 41. It is possible to apply the same window 42 to the two views of FIGS. 4 and 6. In this way, the work of the operator is made considerably easier.

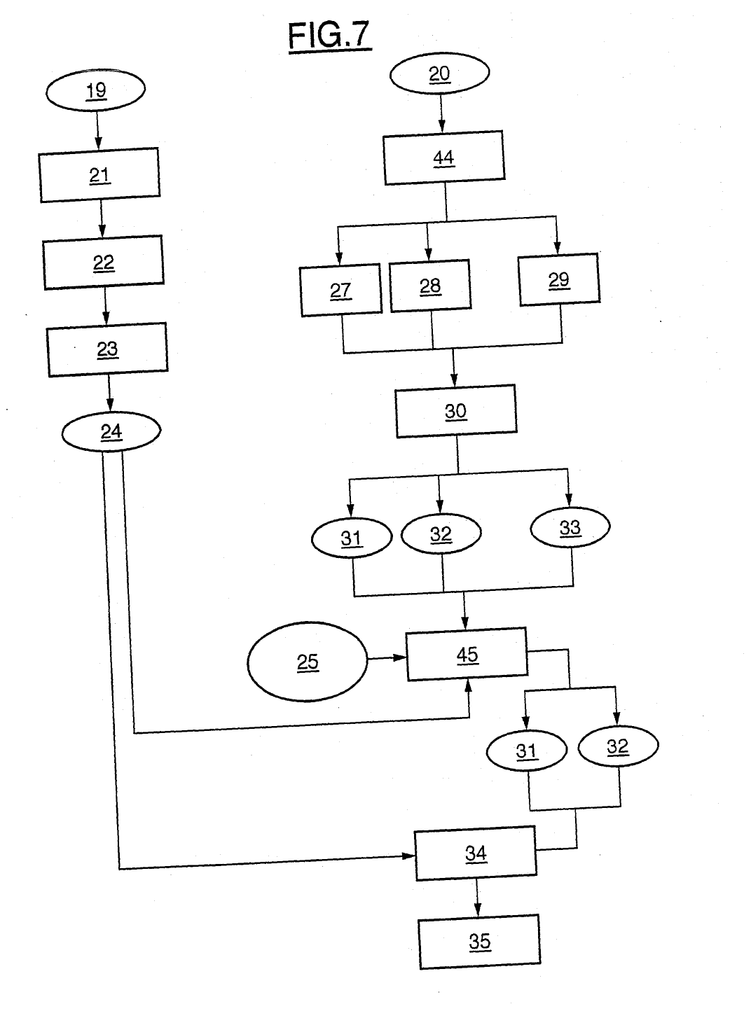

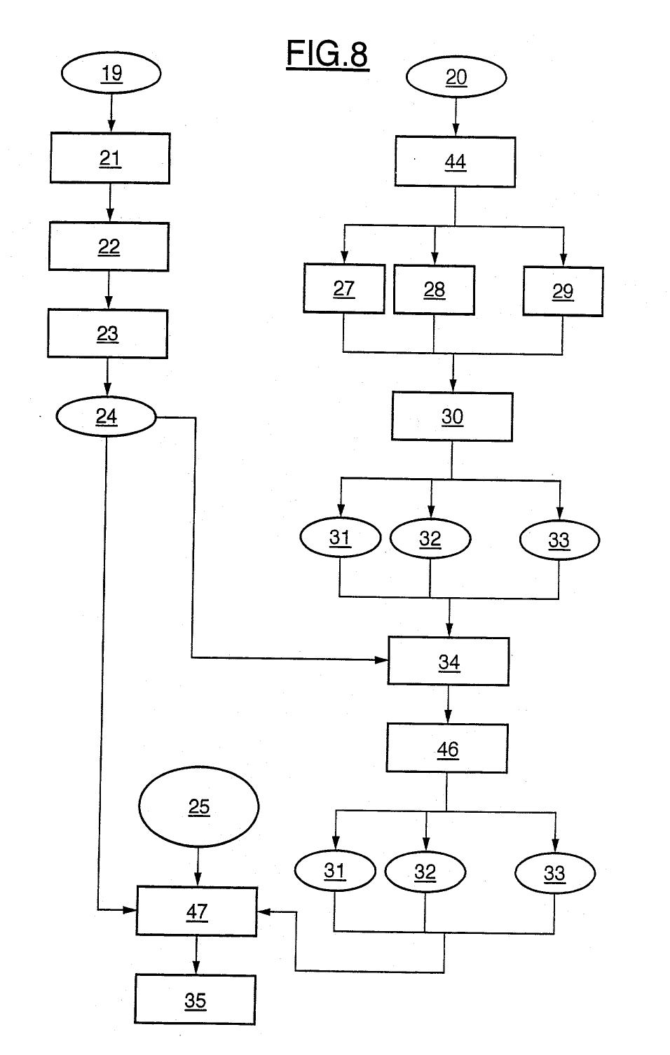

FIG. 7 illustrates steps of a method according to another embodiment of the invention. The steps corresponding to the diagram of FIG. 2 bear the same references. A processing step 44 is applied to the image 20 over the whole image or over a predetermined region, a priori, for example manually or else inside the outline 36 of the object as illustrated in FIGS. 3 to 6. Following step 44, steps 27 to 29 of determining the candidate elements of interest then step 30 of analysing the image to establish the parameter lists 31 to 33 are implemented. Next, a step 45 of selecting candidate elements of interest on the basis of the parameter list 24 for the element of interest of the image 19, of the parameter lists 31 to 33 for the candidate elements of interest of the image 20 and of an organ-deformation and image-acquisition-geometry model 25 are implemented. The selection step 45 makes it possible to remove, for example, one of the candidate elements of interest and on output, only the candidate elements of interest of parameter lists 31 and 32 are kept. Next, a similarity assessment is carried out at step 34, as previously explained with reference to FIG. 2.

FIG. 8 illustrates steps of a method according to another embodiment of the invention. Here, a step 34 of assessing the similarity, taking into account the parameter list 24 and the parameter lists 31 to 33 for the candidate elements of interest of the image 20, are implemented. Then, a threshold step 46 is implemented to remove the candidate elements of interest whose similarity is too slight. On output, a number less than or equal to those upstream of step 34 of the candidate elements of interest are kept. Then, a step 47 of selecting elements of interest on geographical criteria taking into account the candidate elements of interest remaining a the end of step 46 and the element of interest of the image 19 from parameter list 24, and the model 25, are implemented. On output, only a single element of interest of the image 20, considered as the best, is kept and step 35 can then be implemented.

Various modifications in structure and/or steps an/or function may be made by one skilled in the art without departing form the scope and extent of the invention as recited in the claims.

What is claimed is:

1. A method for locating elements of interest in a member from a plurality of images taken at different angulations comprising:
(a) determing elements of interest present in a first image taken at a first angulation;
(b) determining a deformation model of the member between the first angulation and another angulation different from the first is determined in order to deduce there from a search region in another image taken at the other angulation, in which search region an element of interest marked on the first image has a high probability of being found;
(c) determing the element so interest present in the other image; and
(d) analyzing the image of the elements of interest in order to assess their similarity.

2. The method according to claim 1 in which a user determines a region of interest and the image is analyzed in order to determine at least one element of interest present in the region of interest.

3. The method according to claim 1 in which the search region is also deduced from an a priori knowledge of the acquisition geometry.

4. The method according to claim 2 in which the search region is also deduced from an a priori knowledge of the acquisition geometry.

5. The method according to claim 1 in which the similarity of the elements of interest is assessed over all the elements of interest of a search region corresponding to one element of interest of the first image.

6. The method according to claim 2 in which the similarity of the elements of interest is assessed over all the elements of interest of a search region corresponding to one element of interest of the first image.

7. The method according to claim 3 in which the similarity of the elements of interest is assessed over all the elements of interest of a search region corresponding to one element of interest of the first image.

8. The method according to claim 4 in which the similarity of the elements of interest is assessed over all the elements of interest of a search region corresponding to one element of interest of the first image.

9. The method according to claim 1 in which an element of interest is selected in the search region, the said selected element of interest having the highest similarity with the element of interest of the first image for which the search region was determined.

10. The method according to claim 2 in which an element of interest is selected in the search region, the said selected element of interest having the highest similarity with the element of interest of the first image for which the search region was determined.

11. The method according to claim 3 in which an element of interest is selected in the search region, the said selected element of interest having the highest similarity with the element of interest of the first image for which the search region was determined.

12. The method according to claim 4 in which an element of interest is selected in the search region, the said selected element of interest having the highest similarity with the element of interest of the first image for which the search region was determined.

13. The method according to claim 5 in which an element of interest is selected in the search region, the said selected element of interest having the highest similarity with the element of interest of the first image for which the search region was determined.

14. The method according to claim 1 in which the image analysis of the elements of interest to assess their similarity is carried out on the element of interest marked on the first image and on the elements of interest present in the corresponding search region.

15. The method according to claim 2 in which the image analysis of the elements of interest to assess their similarity is carried out on the element of interest marked on the first image and on the elements of interest present in the corresponding search region.

16. The method according to claim 3 in which the image analysis of the elements of interest to assess their similarity is carried out on the element of interest marked on the first image and on the elements of interest present in the corresponding search region.

17. The method according to claim 4 in which the image analysis of the elements of interest to assess their similarity is carried out on the element of interest marked on the first image and on the elements of interest present in the corresponding search region.

18. The method according to claim 5 in which the image analysis of the elements of interest to assess their similarity is carried out on the element of interest marked on the first image and on the elements of interest present in the corresponding search region.

19. The method according to claim 9 in which the image analysis of the elements of interest to assess their similarity is carried out on the element of interest marked on the first image and on the elements of interest present in the corresponding search region.

20. The method according to claim 1 in which the image analysis of the elements of interest provides a list of parameters which can be compared.

21. The method according to claim 2 in which the image analysis of the elements of interest provides a list of parameters which can be compared.

22. The method according to claim 3 in which the image analysis of the elements of interest provides a list of parameters which can be compared.

23. The method according to claim 4 in which the image analysis of the elements of interest provides a list of parameters which can be compared.

24. The method according to claim 5 in which the image analysis of the elements of interest provides a list of parameters which can be compared.

25. The method according to claim 9 in which the image analysis of the elements of interest provides a list of parameters which can be compared.

26. The method according to claim 14 in which the image analysis of the elements of interest provides a list of parameters which can be compared.

27. The method according to claim 1 in which the element of interest marked on the first image and the element of interest of the corresponding search region on the other image estimated as having the greatest similarity with the element of interest marked on the first image, are displayed in a particular manner.

28. The method according to claim 2 in which the element of interest marked on the first image and the element of interest of the corresponding search region on the other image estimated as having the greatest similarity with the element of interest marked on the first image, are displayed in a particular manner.

29. The method according to claim 3 in which the element of interest marked on the first image and the element of interest of the corresponding search region on the other image estimated as having the greatest similarity with the element of interest marked on the first image, are displayed in a particular manner.

30. The method according to claim 4 in which the element of interest marked on the first image and the element of interest of the corresponding search region on the other image estimated as having the greatest similarity with the element of interest marked on the first image, are displayed in a particular manner.

31. The method according to claim 5 in which the element of interest marked on the first image and the element of interest of the corresponding search region on the other image estimated as having the greatest similarity with the element of interest marked on the first image, are displayed in a particular manner.

32. The method according to claim 9 in which the element of interest marked on the first image and the element of interest of the corresponding search region on the other image estimated as having the greatest similarity with the element of interest marked on the first image, are displayed in a particular manner.

33. The method according to claim 14 in which the element of interest marked on the first image and the element of interest of the corresponding search region on the other image estimated as having the greatest similarity with the element of interest marked on the first image, are displayed in a particular manner.

34. The method according to claim 20 in which the element of interest marked on the first image and the element of interest of the corresponding search region on the other image estimated as having the greatest similarity with the element of interest marked on the first image, are displayed in a particular manner.

35. An imaging system comprising:
(a) means for emitting radiation (1);
(b) means for receiving the radiation (3) connected in rotation to the means for emitting radiation;
(c) means for processing images acquired by the means for receiving; wherein the means for processing comprises:
(d) means for locating elements of interest of a member from a plurality of images taken at different angulations by the means for receiving, the means for locating comprising:
(1) means for determining elements of interest present in a first image taken at a first angulation;
(2) means for determining a deformation model of the member between the first angulation and another angulation different from the first in order to deduce there from a search region in another image taken at the other angulation, in which search region an element of interest marked on the first image has a high probability of being found;
(3) means for determining elements of interest present in the search region; and
(4) means for analyzing the image of the elements of interest in order to assess their similarity.

36. A computer program comprising program code means for implementing a method for locating elements of interest in a member from a plurality of image taken at different angulations, when the program runs on a computer comprising:
(a) determing elements of interest present in a first image taken at a first angulation;
(b) determining a deformation model of the member between the first angulation and another angulation different from the first is determined in order to deduce there from a search region in another image taken at the other angulation, in which search region an element of interest marked on the first image has a high probability of being found;
(c) determing the element so interest present in the other image; and
(d) analyzing the image of the elements of interest in order to assess their similarity.

37. A storage medium that can be read by a device for reading program code means which are stored therein and which is capable of implementing a method for locating elements of interest in a member from a plurality of image taken at different angulations when the program runs on a computer comprising:
(a) determing elements of interest present in a first image taken at a first angulation;
(b) determining a deformation model of the member between the first angulation and another angulation different from the first is determined in order to deduce there from a search region in another image taken at the other angulation, in which search region an element of interest marked on the first image has a high probability of being found;
(c) determing the element so interest present in the other image; and
(d) analyzing the image of the elements of interest in order to assess their similarity.
